(19) United States
(12) Patent Application Publication
(10) Pub. No.: US 2022/0300803 A1
(43) Pub. Date: Sep. 22, 2022

(54) METHOD FOR PERFORMING DILATED CONVOLUTION OPERATION USING ATYPICAL KERNEL PATTERN AND DILATED CONVOLUTIONAL NEURAL NETWORK SYSTEM USING THE SAME

(71) Applicant: ELECTRONICS AND TELECOMMUNICATIONS RESEARCH INSTITUTE, Daejeon (KR)

(72) Inventors: Hyun-Woo CHO, Daejeon (KR); Jeong-Si KIM, Daejeon (KR); Hong-Soog KIM, Daejeon (KR); Jin-Wuk SEOK, Daejeon (KR); Seung-Tae HONG, Daejeon (KR)

(21) Appl. No.: 17/342,354

(22) Filed: Jun. 8, 2021

(30) Foreign Application Priority Data
Mar. 22, 2021 (KR) 10-2021-0036463

(51) Int. Cl. G06N 3/08; G06N 3/04

(52) U.S. Cl. CPC G06N 3/08; G06N 3/04

(57) ABSTRACT

Disclosed herein are a method for performing a dilated convolution operation using an atypical kernel pattern and a dilated convolutional neural network system using the same. The method for performing a dilated convolution operation includes learning a weight matrix for a kernel of dilated convolution through deep learning, generating an atypical kernel pattern based on the learned weight matrix, and performing a dilated convolution operation on input data by applying the atypical kernel pattern to a kernel of a dilated convolutional neural network.

### CROSS REFERENCE TO RELATED APPLICATION

This application claims the benefit of Korean Patent Application No. 10-2021-0036463, filed Mar. 22, 2021, which is hereby incorporated by reference in its entirety into this application.

### BACKGROUND OF THE INVENTION

### 1. Technical Field

The present invention relates generally to a new type of dilated convolution technology used in a deep-learning convolutional neural network, and more particularly to technology that improves the degree of freedom in a kernel pattern and allows the kernel pattern to be learned.

### 2. Description of the Related Art

Convolution used in a Convolutional Neural network (CNN) in vision fields often means two-dimensional (2D) convolution. The reason for the ‘2D convolution’ appellation is that a convolution operation is performed while moving in horizontal and vertical directions for input data (image).

Learning in vision fields is performed in a manner in which features related to a large area and a small area are effectively learned without losing such spatial information (horizontal and vertical information). Simply performing convolution on a large area incurs an excessively high computational load. Therefore, the CNN in vision fields traditionally performs convolution in a manner that includes down-sampling of data by inserting a pooling layer between layers, or by increasing the movement width (i.e., stride) of a convolution operation.

When down-sampling is performed in this way, up-sampling or convolution of providing such an effect, such as de-convolution or transpose convolution, must be performed in order to derive final learning results in the output stage of a CNN.

### PRIOR ART DOCUMENTS

### Patent Documents

(Patent Document 1) Korean Patent Application Publication No. 10-2020-0084808, Date of publication: Jul. 13, 2020 (Title: Method and System for Performing Dilated Convolution Operation in Neural Network)

### SUMMARY OF THE INVENTION

Accordingly, the present invention has been made keeping in mind the above problems occurring in the prior art, and an object of the present invention is to provide a new convolution layer, which inherits the advantage of conventional dilated convolution technology and increases the degree of freedom of a kernel pattern while maintaining the receptive field and sparsity of a dilated convolution so as to improve learning accuracy, thus improving the accuracy of learning.

Another object of the present invention is to provide a method for allowing a deep-learning network to learn by itself a new kernel pattern that is to be applied to a dilated convolution in a train phase.

A further object of the present invention is to increase a receptive field compared to a convolution using down-sampling without increasing a computational load, and to reduce an up-sampling or de-convolution cost in an output stage.

Still another object of the present invention is to assign the degree of freedom of a pattern so that better results can be obtained during a process for learning a dataset without fixing the kernel or filter pattern of a dilated convolution.

In accordance with an aspect of the present invention to accomplish the above objects, there is provided a method for performing a dilated convolution operation, including learning a weight matrix for a kernel of dilated convolution through deep learning; generating an atypical kernel pattern based on the learned weight matrix; and performing a dilated convolution operation on input data by applying the atypical kernel pattern to a kernel of a dilated convolutional neural network.

Learning the weight matrix may include moving a location of a target element having a weight other than ‘0’ in the weight matrix in a direction in which a value of a loss function to which a regularization technique is applied is minimized.

Learning the weight matrix may be configured to perform the learning to satisfy a constraint that is set depending on a degree of freedom of the kernel in consideration of learning parameters defined based on space information of the weight matrix.

The learning parameters may include a base kernel size, a receptive field size, and sparsity corresponding to a value obtained by dividing the receptive field size by the base kernel size.

Learning the weight matrix may be configured to perform the learning while maintaining the receptive field size and the sparsity.

The atypical kernel pattern may have a form corresponding to any one of a completely-free form, a vertex-fixed form, an edge-limited form, and a group-limited form depending on the constraint.

Moving the location of the target element may be configured to, when a weight loss value of the target element is greater than a hyperparameter of a proximal operation for regularization, move the location of the target element to any one of multiple adjacent elements.

The multiple adjacent elements may correspond to elements that are adjacent to the target element and have a weight of ‘0’.

Moving the location of the target element may be configured to determine a movement direction of the target element in consideration of a sparse coding value of an activated element located closest to the target element in directions facing the multiple adjacent elements.

Moving the location of the target element may be configured to, after the target element has been moved from a current location thereof, set a weight of an element corresponding to the current location to ‘0’.

In accordance with another aspect of the present invention to accomplish the above objects, there is provided a dilated convolutional neural network system, including a processor for learning a weight matrix for a kernel of dilated convolution through deep learning, generating an atypical kernel pattern based on the learned weight matrix, and performing a dilated convolution operation on input data by applying the atypical kernel pattern to a kernel of a dilated convolutional neural network; and a memory for storing the atypical kernel pattern.

The processor may be configured to move a location of a target element having a weight other than ‘0’ in the weight matrix in a direction in which a value of a loss function to which a regularization technique is applied is minimized

The processor may be configured to perform the learning to satisfy a constraint that is set depending on a degree of freedom of the kernel in consideration of learning parameters defined based on space information of the weight matrix.

The learning parameters may include a base kernel size, a receptive field size, and sparsity corresponding to a value obtained by dividing the receptive field size by the base kernel size.

The processor may be configured to perform the learning while maintaining the receptive field size and the sparsity.

The atypical kernel pattern may have a form corresponding to any one of a completely-free form, a vertex-fixed form, an edge-limited form, and a group-limited form depending on the constraint.

The processor may be configured to, when a weight loss value of the target element is greater than a hyperparameter of a proximal operation for regularization, move the location of the target element to any one of multiple adjacent elements.

The multiple adjacent elements may correspond to elements that are adjacent to the target element and have a weight of ‘0’.

The processor may be configured to determine a movement direction of the target element in consideration of a sparse coding value of an activated element located closest to the target element in directions facing the multiple adjacent elements.

The processor may be configured to, after the target element has been moved from a current location thereof, set a weight of an element corresponding to the current location to ‘0’.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an operation flowchart illustrating a method for performing a dilated convolution operation using an atypical kernel pattern according to an embodiment of the present invention;

FIG. 2 is a diagram illustrating an example of a 2D convolution operation in a convolutional neural network;

FIG. 3 is a diagram illustrating an example of the detailed operation of the 2D convolution operation illustrated in FIG. 2;

FIG. 4 is a diagram illustrating an example of a starting form of a learnable dilated convolution kernel according to the present invention;

FIGS. 5 to 8 are diagrams illustrating examples of an atypical kernel pattern according to the present invention;

FIG. 9 is a diagram illustrating the number of movement cases for a target element according to the present invention;

FIG. 10 is a diagram illustrating an example of calculation of the movement of a target element according to the present invention;

FIGS. 11 and 12 are diagrams illustrating the number of movement cases when a constraint is an edge-limited form according to the present invention;

FIGS. 13 to 16 are diagrams illustrating examples of the result of learning the kernel pattern of a dilated convolution according to the present invention;

FIG. 17 is a block diagram illustrating a dilated convolutional neural network system according to an embodiment of the present invention; and

FIG. 18 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

First, various types of convolutions used in a convolutional neural network will be described in brief so as to more definitely describe the present invention.

In a typical 2D convolution, both input data and a filter (a collection of kernels) may correspond to three-dimensional (3D) data. Therefore, an output value resulting from a convolution between the input data and the filter theoretically corresponds to 3D data where 3D is made of height, width, and depth (also known as channel). However, only if Equation (1) is satisfied, the result of Equation (1) may be output as 2D data.

the number of channels in input data=depth of filters (or the number of kernels) for convolutional operation (1)

Here, 2D convolution is characterized as the convolution that the number of input channels is identical to the number of channels of the filter. Instead, if the number of the channels of the filter is less than the number of input channels, 3D convolution may be performed.

When Equation (1) is satisfied, the filter is moved only in a horizontal or vertical direction, and cannot be moved in a depth direction. Most of all CNNs (Convolutional Neural Networks), since such 2D convolutions are used, the filter is described by a 2D kernel size (height and width) rather than in a 3D dimension (height, width, and depth). For example, assuming that ‘a 5×5 filter was used’, it may be presumed that the depth of the corresponding filter (or the number of kernels) is equal to the number of channels of input data.

In deep learning, it defines the term “kernel” as the depth-wise 2D slice of a filter matrix (or a tensor) for convolutional operations, but as far as a 2D convolution is concerned, thus the use of terms between filter and the kernel are often mixed up. Strictly speaking, as for the filter in convolution, “kernel” or the “depth” may have to be used instead of “channel” for indicating another dimension followed by height and width, but as a widely accepted convention, the three of notation (i.e. the number of kernels, the number of channels of filter, or the depth of filter) are used as the same in the present invention.

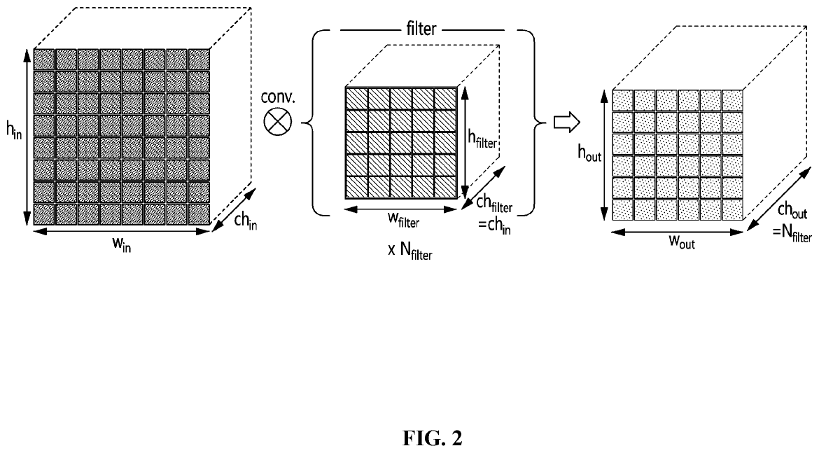

As illustrated in FIG. 2, when convolution is performed on input data while a single filter is sliding horizontally and vertically, output thereof is generated on one 2D surface. In this case, the reason why the output generated after the convolutional operation of FIG. 2 is 3D is that several different filters N_{filter} are used.

Convolution in CNNs is a procedure for multiplying input element by filter element for all overlapped matrix and summating all of them, which makes one output element, and repeatedly calculating those as the filter is sliding with stride for composing of complete output matrix. Therefore, convolutional operation is a very computation-intensive, but simple and repeated process of multiplication and addition.

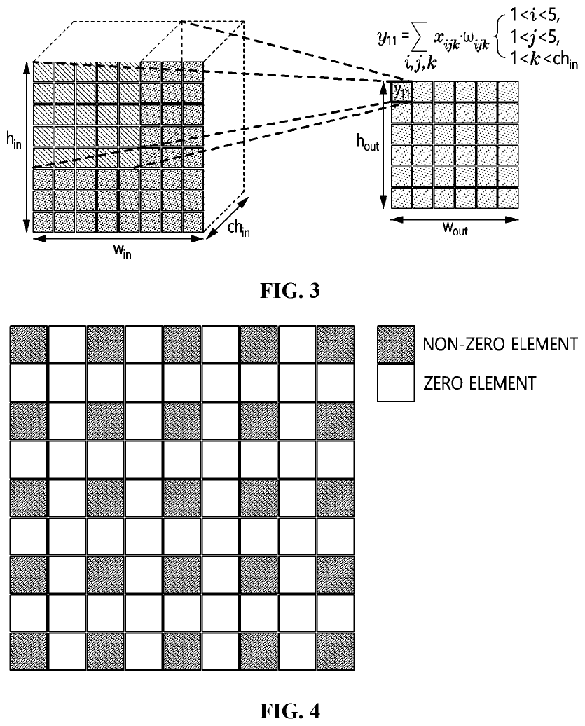

In such 2D convolution, since the depth of input data (number of channels) and the filter depth (number of kernels) are always equal to each other, there are many cases in which convolution is illustrated as being a 2D section for convenience of illustration, rather than being illustrated in a 3D structure, as illustrated in FIG. 3.

In the present invention, all subsequent convolutions (convolutional operations) are illustrated as being 2D sections. However, a meaning contained in each convolution is to derive the value from multiplications and additions for a 3D tensor.

Further, when it is considered to categorize generic connection between neurons in neural networks, the convolution layer is a kind of locally connected layer (hereinafter referred to as “LC”), where convolution has a specific feature that its connections share the same weights regardless of locally connected region with input data. In order to describe the same in greater detail, a fully connected layer (hereinafter referred to as “FC”) is described first prior to the LC.

Assuming a simple neural network that sizes of its input and output are both the same. For easy understanding, in the case where the description is limited to the vision field, input data may be an image with a resolution of 640 by 480. Each pixel of the image can be considered as a node (or neuron) of this neural network. Then, according to the assumption, it has the same number of input and output nodes (this is, 640*480) and each node at input are fully connected with all nodes at output, like a mesh.

In the neural network, output node y may be the sum of all inputs x connected with, but their connections may have different importance, so that they should multiply different values of each input (this is, all connections have their own weights w). In the FC, the first output node y(1,1) is represented by the following Equation (2):

y_{1,1}=Σⱼ₌₁⁴⁸⁰ρᵢ₌₁⁶⁴⁰(x_{i,j}·ω_{i,j}) (2)

That is, in order to calculate only one output node in the FC, a filter having a 640×480 kernel size is required. According above assumption, different 640×480 filters in total for the FC are required. That is, as shown in Equation (3), where i and j are indices for input nodes, on the other side, h and w for output, it can be seen that a massive amount of calculation is needed.

y_{h,w}=Σⱼ₌₁⁴⁸⁰Σᵢ₌₁⁶⁴⁰(x_{i,j}·ω_{i,j}^{h,w)}, where h=1, . . . , 480,w=1, . . . ,640 (3)

If only any input and output nodes are partially connected with, it may be considered as the LC theoretically. However, it usually means that consecutive nodes or nodes for a certain region at input (this is, not scattered), are connected with an output node. For example, if a first node at the output y(1,1) is connected to nodes corresponding to first 5 by 5 portion of input, this “local” connection may be represented by the following Equation (4):

y_{1,1}=Σⱼ₌₁⁵Σᵢ₌₁⁵(x_{i,j}·ω_{i,j}^{1,1}) (4)

That is, compared to Equation (2) in FC, a computational load may be reduced in proportion to reduction in the size of the filter in LC.

If they do not have any constraint other than the size, a second node at the output may be connected to another group of input nodes, as shown in the following Equation (5). What is notable is that these weights w(2,1) in Equation (4) may be different from those w(1,1) in Equation (4).

y _{2,1}=Σⱼ₌₁⁵Σₜ₌₂⁶(x_{i,j}·ω_{i,j}^{2,1}) (5)

That is, in spite of LC, filters may be generally required as many numbers as output nodes (in this example, 640*480).

However, if the LCs have the same size (in this example, 5 by 5) and it can share the same weight regardless of which region they are connected to, only one weight matrix for all output nodes is enough. It can behave like filtering data with the same pattern in signal processing or computer vision; the term “filter” is derived from that. In Equation (6), ω_{i,j} is equal in all LC filters regardless of h and w.

y_{h,w}=Σⱼ₌₆₀^{a+4}Σ_{i=b}^{b+4}(x_{i,j}·ω_{i,j}) (6)

Here, convolution in the neural network may be exactly the same as the situation of Equation (6). The filter (Kernel) may be connected to part of the input data, and the weight of the filter may be shared regardless of the connected location. It is based on the assumption if the extraction of certain characteristics at a specific location (x, y) on an image is useful, then it may also be useful at another location (x′, y′).

In most vision-related problems in the deep learning, the assumption related to such weight sharing is known as it works well to train the neural networks. Of course, this assumption may be unsuitable in some area. If it were more important that totally different features would be learned for respective regions, LC with different weights matrix would be used. The following Table 1 shows the results of a comparison between calculations (operations) and the number of learnable parameters (weights) in respective connection types, for the examples in Equations (2) to (6). Note that multiplication and addition combined is approximately counted as one (1) for clearer comparison.

TABLE 1

| | Connection | | |
|---|---|---|---|
| | FC | LC | |
| | Weights sharing | | |
| | different | different | weights-shared = |
| | weights | weights | convolution |
| Kernel size (=the | 640 × 480 | 5 × 5 | 5 × 5 |
| number of connections) | | | |
| Number of filters (=the | 640 × 480 | 640 × 480 | 1 |
| output size) | | | |
| Total multiplication and | 640 × 480 × | 5 × 5 × | 5 × 5 × 640 × 480 |
| addition (approx.) | 640 × 480 | 640 × 480 | |
| Learnable parameters | 640 × 480 × | 5 × 5 × | 5 × 5 |
| (weights) | 640 × 480 | 640 × 480 | |

Here, referring back to convolution, the convolution layer shares the weights of filters regardless of which portion of input data is connected to an output node, and thus it can be seen that the convolutional operation is performed while the filter horizontally or vertically slides on the input data.

Here, it should be noted that, in Table 1, total multiplication and addition is about the case where 2D output data having the same size as the input data is obtained, for the purpose of comparison. However, the output of a convolutional layer in the actual convolutional neural network may be formed as 3D data. The reason for this is that many filters, not only one, are used in the convolution layer.

That is, referring to Table 1, although a computational load seems to have been sufficiently reduced, since the number of filters is pretty much big in a convolution layer and the convolutional neural network is usually formed by stacking a large number of such layers, and thus the convolutional neural network may still be computation-intensive. Extracting feature-maps enough to classify what object is from an image using multiple filters in this way is the core of the convolutional neural network.

Meanwhile, it may be preferable to perform extraction of features through convolution on the small area and gradually on larger area in an input image. For this, an input node region the filter can cover is called a “receptive field”. That is, it may be preferable to extract features as gradually widening the receptive field. The most intuitive method is to simply increase the size of the filter. However, because this method gives the fatal disadvantage on the computational load, it is hard to apply the method to the convolutional neural network.

Therefore, there is a method of performing down-sampling even if some information is lost. Examples of this method include max-pooling for taking a maximum value, average-pooling for taking an average value, etc. It has an effect like reducing a resolution of an image. When convolution is performed after down-sampling, it can make the receptive field wider without any change of filter size.

Further, through convolution, the effect of down-sampling may also be obtained by the filter with stride>1, wherein setting of strides=2 means that the filter is moved by two (skipped by one spaces). That is, this method may be a scheme that learn down-sampling as well as extraction of features in some ways.

The convolutional neural network to be applied to image classification tasks in many cases contains some convolution layers having stride=2and one or two pooling layers for down-sampling. Here, object detection tasks are also based on image classification, but location information (where the objects are) must also be predicted. Therefore, both of them can use a similar backbone convolutional neural network, but as the neural networks are deeper, an output result (feature map) is decreased to an excessively small size, and thus they need to make a resolution increased back (it is called “up-sampling”). On this up-sampling technique, linear interpolation may be most simply and easily applied.

This scheme is intended to forcibly increase resolution using the current value regardless of information that is lost during down-sampling, and thus error is inevitably increased. Alternatively, a scheme for recording which pixel has been selected during max-pooling and utilizing the selected pixel during up-sampling may produce better results.

The two methods described above may increase an output size using a designated algorithm without any learnable parameters. However, similar to convolution (stride>1) for down-sampling, convolution may be performed even for up-sampling. By utilizing this scheme, up-sampling may also be determined to be learned by the neural networks rather than through a designated algorithm.

Here, de-convolution, which is up-sampling using convolution, may be implemented by performing convolution while inserting padding between pieces of input data one by one. Therefore, from the standpoint of the filter, one space is moved only whenever movement is performed twice, and thus it may be considered that stride=0.5. The following Table 2 shows a summary of types of convolution depending on output sizes.

TABLE 2

| Operation | | Down-sampling | Convolution | Up-sampling |
|---|---|---|---|---|
| Feature map | | decreased | same | increased |
| (output size) | | | | |
| Method | Non- | pooling | — | un-pooling(max), |
| | learning | (max, avg) | | bilinear, nearest, etc. |
| | Learnable | Convolution | convolution | de-convolution |
| | | (stride > 1) | (stride = 1) | (stride < 1) |

| | | | |
|---|---|---|---|
| Padding | Inserted into | Inserted into | Inserted between |
| | edge | edge | pieces of data |
| | | | (not applicable |
| | | | to un-pooling) |

Here, a method of performing learning while increasing the receptive field using a down-sampling technique may be an object-centric learning method. The CNNs may learn on a lot of image data, and only robust features that are unchanged may be extracted from the big data. In other words, borders for image object may inevitably be learned with low certainty.

Here, because a bounding box used for location detection does not also need to extract a very fine boundary line, image detection may be satisfactorily performed using only an up-sampling technique, which exhibits high performance in class classification.

However, for image segmentation, the features of the entire boundary line (contour) must be extracted, and thus there is a need to increase the receptive field. However, if features are extracted by increasing the receptive field simply through down-sampling, larger receptive filed, more loss for spatial information it may cause, and thus it may be difficult to extract a precise boundary line even if up-sampling is performed afterwards. As a result, it is required to increase the receptive field without down-sampling, and prevent a computational load from greatly increasing at the same time.

Dilated convolution may be a good solution. This convolution increases the receptive field without down-sampling. They may make it by padding even to the inside of the filter, whereas all of conventional convolution are padding only into input data. That is, the receptive field is increased by a sparse filter, but a computational load may keep low. Further, because they are not any down-sampling operation, an error or a computational load that may occur in a subsequent up-sampling procedure may be mitigated.

Table 3 shows the types of convolution depending on the dilation of a receptive field.

TABLE 3

| | Convolution | Convolution | Dilated convolution |
|---|---|---|---|
| Type | (stride > 1) | (stride = 1) | (stride = 1) |
| Down-sampling | O | X | X |
| | (output size is decreased) | (output size is equal) | (output size is equal) |
| Receptive field | Increased in subsequent | Equal in current and | Increased in current |
| | convolution | subsequent convolution | convolution |
| Sparsity of feature | Low | High | High |
| extraction | | | |
| Sparsity of filter | High | High | Low |

Further, because all of these convolutions basically have a feature of weight-sharing LC, it is possible to remarkably reduce a computational load and the number of learnable parameters compared to FC. In spite of this advantage, most of embedded devices are provided with greatly limited computing resources, and thus an attempt to further decrease the computational load of typical convolution has been actively conducted. As described above with reference to FIG. 2, 2D convolution may actually perform an operation (calculation) on 3D data. Therefore, Google proposed a novel model called “MobileNet” for mobile devices, using a scheme for separating data for respective channels and performing convolution by separate filters on each channels, rather than by 3D filter on all the channels simultaneously.

The proposed convolution is differentiated from typical 2D convolution in that the filters have only one depth. When convolution is performed for respective channels, information for the same space can be separated to different channels and extracted for respective channels. Therefore, there is required a mean for merging the pieces of separated information, and for this, lx1 convolution or pointwise convolution may be used.

Through two steps of convolution performed in this way, a feature extraction function similar to typical 2D convolution may be performed. This means that configuration of a 3D filter is divided into a 2D portion (height and width) and a 1D portion (depth) and calculation is performed thereon, and is commonly referred to as ‘factorized convolution’. This two-step convolution made of depthwise separable convolution and then pointwise convolution is called “depthwise convolution”.

From the standpoint only of factorization, it is possible to separate a 3D filter of typical 2D convolution into filter components for all dimensions and separately perform calculation. This scheme may correspond to a spatially separable scheme for, even for a 2D plane, primarily performing calculation in a height direction and then subsequently performing calculation in a width direction.

Depthwise convolution may be regarded as a special example of grouped convolution. That is, this may correspond to the case of group size=the number of channels (depth size). Similar to depthwise convolution, space information may be separated and extracted for respective groups. In AlexNet, in order to merge the separated information, simple concatenation, rather than pointwise convolution, is performed. Therefore, unlike depthwise separable convolution, AlexNet is characterized in that extraction of features from the same group is not shuffled with extraction of features from other groups. A research team that proposed shuffleNet to compensate for concatenation performs group convolution at two steps, but interposes a channel-shuffling operation between the two steps of group convolution, thus enabling the features extracted for respective groups to be convoluted together. The following Table 4 summarizes a method of factorizing a typical 2D convolution operation.

TABLE 4

| | 2D-spatial | Grouped | Depthwise | Spatially | |
|---|---|---|---|---|---|
| Convolution | convolution | convolution | separable | separable | |
| Rank of | 3D | 3D | 2D + ID | 2D + 2D (+1D) | |
| filters | | | | | |
| Dimension | H_{f} < Hᵢₙ | H_{f} < Hᵢₙ | H_{f} < Hᵢₙ | H_{f} < Hᵢₙ | H_{f} = 1 |
| of filters | W_{f} < Wᵢₙ | W_{f} < Wᵢₙ | W_{f} < Wᵢₙ | W_{f} < 1 | W_{f} < Wᵢₙ |
| | C_{f} = Cᵢₙ | C_{f} = Cᵢₙ | C_{f} = Cᵢₙ | C_{f} = Cᵢₙ | C_{f} = Cᵢₙ |

| | | | | |
|---|---|---|---|---|
| Step to | 1 step | 1 step and | 2 steps | 2 steps |
| convolution | | concatenation | | (+pointwise) |

Here, because pointwise convolution (1×1 convolution) merges pieces of space information that are scattered for respective channels through convolutional learning, rather than simple concatenation, it may desirably realize the meaning of the original 2D convolution operation. Further, when spatial information for each channel is regarded as one feature map, 1×1 convolution may perform an operation such as that of FC. It may be assumed that the number of channels of input data is the number of input nodes of FC, and that the number of 1×1 convolution filters, that is, the number of channels of output data, is the number of output nodes of FC. Here, 1×1 convolution may provide the effect of changing the number of channels while basically maintaining space information (i.e., maintaining the same height and same width). Unless the input/output nodes of FC are limited in one dimension, 1×1 convolution may be exactly identical to that of FC.

Flattening through this 1×1 convolution is useful from the standpoint of maintenance of spatial information. This may be extended to a 3D space without being limited to spatial information.

This may be similar to the addition of spatially separable convolution to pointwise convolution. However, there may be a difference in that flattening uses a 1D filter, similar to 1×1 convolution. In comparison with typical 2D convolution, this may be similar to performing convolution using a filter having the same size as the input data. This operation may be understood to be deformation or extension of pointwise convolution, but the actual usefulness thereof may be deteriorated. The following Table 5 shows the result of a comparison between convolution types.

TABLE 5

| | Convolution | | | | | |
|---|---|---|---|---|---|---|
| | Spatially separable | | Pointwise | Flattened convolution | | |
| | Rank of filters | | | | | |
| | 2 D | +2 D | +1 D | 1 D | +1 D | +1 D |
| Dimension of | H_{f} < Hᵢₙ | H_{f} = 1 | H_{f} = 1 | H_{f} = 1 | H_{f} = Hᵢₙ | H_{f} = 1 |
| filters | W_{f} = 1 | W_{f} < Wᵢₙ | W_{f} = 1 | W_{f} = 1 | W_{f} = 1 | W_{f} = Wᵢₙ |
| | C_{f} = Cᵢₙ | C_{f} = Cᵢₙ | C_{f} = Cᵢₙ | C_{f} = Cᵢₙ | C_{f} = 1 | C_{f} = 1 |

These convolution types have important functions such as the extraction of features from spatial information. Depthwise convolution is capable of reducing computational load by separating channels while maintaining these features. The features for separated channels are merged through 1×1 convolution. Further, in order to extract comprehensive spatial information, it is general to perform convolution while gradually increasing the receptive field of convolution. There is a research team holding the opinion that, in depthwise separable convolution, depthwise convolution functions to collect spatial information, and 1×1 convolution is configured to extract features from collected spatial information. The team has asserted that collection of spatial information only needs to arrange spaces simply aligned for respective channels so that the aligned spaces are slightly deviated from original locations for respective channels.

The present invention is intended to provide a new dilated convolutional layer, to which an atypical kernel pattern, which is capable of improving precision of learning while inheriting the advantage of the above-described dilated convolution technology, is applied, and a method for allowing a deep-learning network to learn by itself the atypical kernel pattern in a train phase.

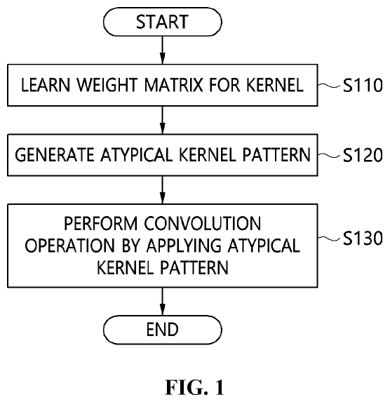

FIG. 1 is an operation flowchart illustrating a method for performing a dilated convolution operation using an atypical kernel pattern according to an embodiment of the present invention.

Referring to FIG. 1, the method for performing a dilated convolution operation using an atypical kernel pattern according to the embodiment of the present invention learns a weight matrix for the kernel of dilated convolution through deep learning at step S110.

Here, because the kernel of new dilated convolution proposed in the present invention has a high degree of freedom, a very large amount of trial and error may occur during a process in which a human manually sets an optimal heat point distribution. Therefore, it is an important point to allow a deep-learning network to learn this process in order to increase effectiveness.

Here, because the result of dilated convolution, the degree of freedom of which is increased, is similar to that of sparse coding, the process thereof will be described below, and a portion adopted in the present invention and a dilated portion will be compared with each other.

Here, the location of a target element (also referred as a heat point above), the weight of which is not ‘0’ in the weight matrix, may be moved in the direction in which the value of a loss function to which a regularization technique is applied is minimized.

That is, in deep learning, sparse coding enables learning to be performed by applying the regularization technique to a loss function or a cost function in a train phase.

The term “regularization” may mean a technique for mitigating overfitting of the result of learning to learning data because the deep-learning network has excessively many representations or because learning data (or training data) is not sufficient. Here, the loss function to which the most basic L2 regularizer is added may be represented by the following Equation (7):

$$C ( ω ) = {C}_{0} ( ω ) + \frac{λ}{2} {‖ ω ‖}_{2}^{2} \qquad ( 7 )$$

Here, C₀ denotes an original cost function, λ denotes a regularization parameter, and ω denotes weights.

Here, individual symbols in the above Equation will be described in detail below.

The loss function C₀(ω) of deep learning may be represented by the following Equation (8):

C₀(ω)=Σᵢ₌₀^{N}(yᵢ−Σⱼ₌₀^{M}xᵢⱼ·ωⱼ)² (8)

Here, Y denotes an output (correct answer) matrix, and X·W denotes a (predicted) value, obtained by calculating the inner product of an input matrix X and the matrix W of a weight filter. Here, the size of the weight matrix (=width*height*depth) may be M, and the size of the output matrix (=width*height* depth) may be N. Also, after the convolution operation has been performed, N may be determined by a function of the size of the input matrix including padding, the size of the filter matrix, and the stride of the filter.

Further, when constants are omitted from the regularizer, a remainder may correspond to L2 norm, represented by the following Equation (9):

L2(\vec{V})=∥\vec{V}∥₂=\sqrt{Σᵢv²} (9)

Here, because a root merely increases a computational load without assigning a great meaning, the square form of the L2 norm such as that shown in the following Equation (10) may be generally and widely used.

∥\vec{V}∥₂²=Σᵢv² (10)

Here, the constant λ introduced in the regularizer is a hyperparameter of regularization. Generally, the term “hyperparameter” may be an experimentally set value depending on the type of input data, the learning target, the network model, or the like.

Here, constants attached to the Equation have multiple variants, but most variants may be made for convenience of calculation, and may not have fundamental differences there between. Here, in Equation (7), the reason for dividing the corresponding parameter by 2 is to remove a constant coefficient that remains when the equation is differentiated.

In learning performed in deep learning, weights may be updated using a scheme for subtracting the gradient of loss (i.e., a differential value of the loss function), which is obtained through the current weight using the actual loss function, from the current weight. This method is often called “gradient descent”. When this operation is represented by a formula, it may be represented by Equation (11).

$$ω \to ω - η \frac{\partial C}{\partial ω} \qquad ( 11 )$$

Here, η denotes a learning rate for adjusting the speed of weight update in deep learning.

Here, when Equation (7) is substituted into Equation (11), Equation (12) may be obtained.

$$\begin{matrix}ω \to ω - η \frac{\partial ( {C}_{0} + \frac{λ}{2} {‖ ω ‖}_{2}^{2} )}{\partial ω} = ω - η ( \frac{\partial {C}_{0}}{\partial ω} + \frac{λ}{2} \cdot 2 {\sum }_{i} {ω}_{i} ) \\ = ( ω - η \frac{\partial {C}_{0}}{\partial ω} ) - η \cdot λ {\sum }_{i} {ω}_{i}\end{matrix} \qquad ( 12 )$$

Furthermore, because L2 regularization uses the sum of squared values, it may correspond to distance.

Because this value is added to the loss function, when the weight is updated to decrease the loss, L2 regularization is designed such that the weights are reduced in proportion to the sum of weights, thus preventing the weights from being divergent. When regularization is added in this way, the overfitting causing due to insufficient training data may be mitigated.

Further, L1 regularization also has the same object, that is, to prevent weights from being divergent. However, L1 regularization may make use of the sum of the absolute values of weights, rather than the distance between weights.

Because L2 regularization is related to the distance between weights that is obtained by summing the squares of all weights, every elements of the weight matrix are necessarily associated with finding the distance, which means the only one path to the right answer can exist.

On the contrary, for the sum of absolute values, many alternative paths may occur to the goal. That is, some weights may be unessential to get the same answer. In this meaning, L1 regularization, such as that shown in Equation (13), may be suitable for application to sparse coding. Since some elements in weight matrix may be ignored, it is enough for such a sparse matrix to minimize the loss.
L1 Regularization

C(ω)=C₀(ω)+λ∥ω∥₁=C₀(ω)+λΣᵢ|ωᵢ|
L1 Norm

L1(\vec{V})=∥\vec{V}∥₁=Σₗ|vₗ| (13)

Generally speaking, p-th order norm (Lp norm) can be defined like Equation (14).

$$Lp ( \vec{V} ) = {‖ \vec{V} ‖}_{p} := {( {\sum }_{i} {\vert {v}_{i} \vert}^{p} )}^{\frac{1}{p}} \qquad ( 14 )$$

Further, through Equation (14), L0 norm conceptually satisfying p=0 may be derived by the following Equation 15.

$$\begin{matrix}L 0 ( \vec{V} ) = {‖ \vec{V} ‖}_{0} \\ = {i n}_{p \to 0} {( {\sum }_{i} {\vert {v}_{i} \vert}^{p} )}^{\frac{1}{p}} \\ = {\sum }_{i} 1 [ {v}_{i} \neq 0 ]\end{matrix} \qquad ( 15 )$$

Here, in L0 norm, no regularization effect has actually occurred, and thus L0 norm does not normalize anything, neither. Instead, this may correspond to a mathematical concept from what if the value of p is made extremely close to ‘0’. In practice, in a matrix, L0 norm may mean the number of elements other than ‘0’ (i.e., non-zero elements) for one column or one row. Therefore, the L0 norm may be used to approach group regularization.

Hereinafter, how sparse coding can be performed through the above-described regularization technique will be described.

First, the concept of sparse coding is described below.

In deep learning, a weight matrix except special cases, such as dilated convolution, dropout, or pruning, may be a dense matrix filled all elements with values.

Some elements in weight matrix can be eliminated if the value is small (almost close to ‘0’) enough not to have much influence on the prediction through the neural network.

For example, in the convolutions, the inner product of the input and the weight may produce one prediction value. Therefore, when some element of the weight has the value of ‘0’ or a value sufficiently close to ‘0’, the element hardly influences a final prediction value.

It is certain that sparse coding itself has a process beyond that, and may be a scheme coding only non-zero elements in smaller bits. However, in the present invention, this process is not considered.

Here, in the present invention, what is adopted out of the sparse coding is the followings. When weights are updated using L2 or L1 regularization, the weights tend to be entirely decreased (shrunken) because new weights are obtained by subtracting penalty values (differential values of regularized portions) derived from current weights. As a result, when the values of some elements become ‘0’, the weight matrix is considered as sparse one.

As described above, because L2 regularization requires all elements of weight matrix, it cannot be declared that a result obtained by eliminating some elements through sparse coding is optimized. However, since L1 regularization may yield optimal weights without some elements, L1 regularization may be used in most of sparse coding.

A proximal operator may be useful tool to apply L1 regularization in practice. That is, if some elements of weight become sufficiently small along weight update, those elements may be set to ‘0’. Here, the criterion for determining whether or not to be “sufficiently small” is the hyperparameter λ of the proximal operator.

The following Equation (16) shows an example of an L1 proximal operator.

$${P}_{λ {‖ \cdot ‖}_{1}} ( ω ) := \{ \begin{matrix}ω - λ & if ω > λ \\ 0 & if ω ∈ [ - λ , λ ] \\ ω + λ & if ω < - λ\end{matrix} \qquad ( 16 )$$

Here, in order to check the usefulness of the proximal operator, the case where the proximal operator is applied may be compared with the case where the proximal operator is not applied. First, when only L1 regularization is simply applied, weight update may be represented by the following Equation (17):

$$\begin{matrix}ω \to ω - η \frac{\partial C}{\partial ω} = ω - η \frac{\partial ( {C}_{0} + λ {‖ ω ‖}_{1} )}{\partial ω} \\ = ( ω - η \frac{\partial {C}_{0}}{\partial ω} ) - η \cdot λ \frac{\partial {‖ ω ‖}_{1}}{\partial ω}\end{matrix} \qquad ( 17 )$$

Here, because a portion of L1 norm has trouble to be integrated, it may be difficult to actually apply to a deep-learning process. However, except for it, the differential value of the L1 norm may be a constant, which has the same amount but different sign.

On the other hand, weight update performed with the proximal operator may be represented by the following Equation (18):

$$ω \to {P}_{λ {‖ \cdot ‖}_{1}} ( ω - η \frac{\partial {C}_{0}}{\partial ω} ) = \{ \begin{matrix}( ω - η \frac{\partial {C}_{0}}{\partial ω} ) - λ & if ( ω - η \frac{\partial {C}_{0}}{\partial ω} ) > λ \\ 0 & if ( ω - η \frac{\partial {C}_{0}}{\partial ω} ) ∈ [ - λ , λ ] \\ ( ω - η \frac{\partial {C}_{0}}{\partial ω} ) + λ & if ( ω - η \frac{\partial {C}_{0}}{\partial ω} ) < - λ\end{matrix} \qquad ( 18 )$$

Here,

$$ω - η \frac{\partial {c}_{0}}{\partial ω}$$

may correspond to a typically updated weight value regardless of the proximal operator. When the updated value is sufficiently small (when the absolute amount thereof is less than λ), the proximal operator functions to set the updated value to ‘0’, otherwise the proximal operator functions to reduce the magnitude of the weight by adding the constant, but opposite sign of λ or −λ against the sign of

$$ω - η \frac{\partial {c}_{0}}{\partial ω} .$$

Here, as shown in Equation (18), the proximal operator has the form of adding or subtracting a constant in a way similar to that of L1 regularization, and thus it may be called an “L1 proximal operator”. Further, the proximal operator has the effect of L1 regularization in that the absolute value of the weight is decreased.

However, when a value, obtained after weight update, is sufficiently close to ‘0’, there is the effect of forcibly setting the value to ‘0’. Further, because the absolute value of the weight is not differentiated, but an existing loss function is used without change, and approximation is applied to the weight update, the proximal operator may be effectively applied to a deep-learning process.

Meanwhile, the proximal operator may be applied to partially grouped portions of weights, rather than being uniformly applied to all weights. This is intended to group one row or one column, thus sparsifying the column or row. This means that when a group proximal operator is applied to convolution, a kernel pattern similar to that of existing dilated convolution may be obtained.

A procedure for an L1 group proximal operator will be described in brief below.

First, at a first step, update weights such that losses on the current weights are reduced. Next, at a second step, vectorize each group of the updated weights and calculate distance of the vectors (i.e., L2 norm). Finally, at a third step, when the value of the distance of a certain group is sufficiently small, all elements in the corresponding group may be set to ‘0’. If not, that is, the distance is far from threshold, basically maintain all weights in the corresponding group but reduce the magnitudes of them at a specific rate (weight shrinkage). At this time, the specific rate may vary for each group, and may be in inverse proportion to the distance of the corresponding group.

Here, an L0 group proximal operator may also be used for group regularization. This can avoid some side effects coming up when the updated weights are reduced again at the third step in L1 group proximal and decide a hyperparameter for the desired sparsity.

A procedure for the L0 group proximal operator will be described in brief below.

First, at a first step, update weights such that losses on the current weight are reduced. Next, at a second step, vectorize each group of the updated weights and calculate distance of the vectors (i.e., L2 norm). At a third step, sort all L2 norms of groups in ascending order. Finally, at a fourth step, set ‘0’ for all elements of the group if its distance is over the threshold, or let them survive their weights if not. At this time, the threshold is determined by the desired sparsity.

Generally speaking, sparse coding is about how to make the matrix sparse, but the novel dilated convolution proposed in the present invention has already a shape of sparse matrix, so it may not actually execute the sparse coding. Instead, in order to change the locations or distributions of elements other than ‘0’ (non-zero elements) in the sparse matrix, a proximal operation expression used in sparse coding may be modified and utilized.

For this operation, the present invention may introduce the spatial information of the weight matrix as a learnable parameter.

Here, when loss of the target element in weight matrix is greater than the hyperparameter of the proximal operator for regularization, the location of the target element may be shifted to any one of multiple adjacent elements.

In other words, when the loss is propagating backward through the neural networks in train phase, loss at a certain element in weight matrix is greater than the hyperparameter λ of the proximal operator depending on the location of each weight, the corresponding element may be set to ‘0’, and the target element may be shifted to somewhere else that is adjacent thereto.

Since the present invention is intended to extend existing dilated convolution, it is very important not to lose 2D-spatial information on an image, especially for computer vision.

For example, an initial pattern may begin at the same location as the kernel pattern of typical dilated convolution, as illustrated in FIG. 4. At this time, the form illustrated in FIG. 4 is identical to the dilated convolution having a 9*9 receptive field by applying a dilation rate of 2 to 5*5 convolution, and may correspond to sparsity of 81/25. That is, FIG. 4 may be a starting form of a kernel with 25 non-zero target elements among a total of 81 learnable candidates.

Here, regions in which non-zero elements, that is, elements which actually participate in a convolutional operation, are present may be aligned with each other at regular intervals, as illustrated in FIG. 4.

Note that deep learning may be performed while it keeps the same receptive field and sparsity during overall train phase.

On the contrary, the locations of non-zero elements may be optimized while the receptive field size and sparsity are maintained.

Generally, deep learning in train phase may be composed of a forward propagation procedure from input to output, a back-propagation procedure for losses or costs from output to input, and an update (or optimization) procedure for weights and biases at each hidden layer.

Here, the following procedures may be added for dilated convolution for learning proposed in the present invention.

First, in a back-propagation procedure a regularizer may be obtained for the current weight value. Further, a proximal operation is performed on the next weight value just before optimization. If the next weight value is sufficiently small, the corresponding pixel is set to ‘0’, and an adjacent pixel (adjacent element) may be activated. Otherwise, the weight for the corresponding location may be updated to the next weight value.

Here, multiple adjacent elements may correspond to adjacent elements that the target element can shift to and have weights of ‘0’ (zero-elements).

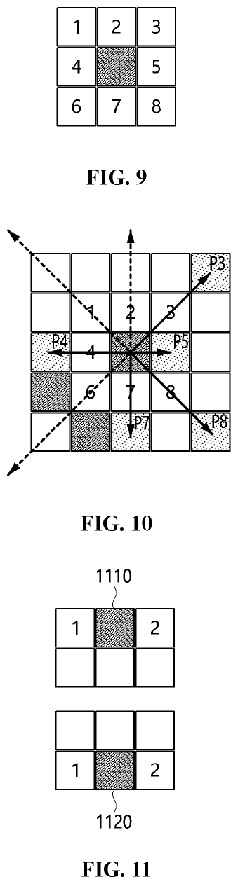

For example, in the case of the highest degree of freedom, elements adjacent thereto (adjacent pixels) may be 8, as illustrated in FIG. 9. That is, when the target element is movable in all directions, rather than being located at an edge or a vertex, a maximum of eight adjacent elements may exist.

Here, there may be a race which one to activate among the adjacent elements. First of all, empty elements can be candidates, rather than current activated elements.

For example, referring to FIG. 10, a cell P5 adjacent to the target element, located at the center of the elements, in the direction of #5 is already filled with a non-zero element, and thus the cell P5 cannot be a candidate so it does not need to calculate activation scores.

It is kind of sparse coding with groups of elements on line in directions facing candidates for finding the movement direction of the target element.

For example, the distance (number of elements) to a point reaching out the first non-zero element in each direction, except for the direction of #5 in FIG. 10, is set to d. That is, in the direction of #3, 4, 7, and 8, d=2 may be obtained, and in the direction of #1, 2, and 6, d>2 may be satisfied. When there is no non-zero element in a given direction, calculation may not be performed.

Here, assuming that the distance to the corresponding element (the number of elements) is d and the result of calculating the regularizer of the corresponding element is r, a sparse coding value (also referred as the activation score above) may be calculated, as represented by the following Equation (19):

$$S ( {ω}_{i} ) = ξ \cdot \frac{r ( {ω}_{i} )}{{d}^{2}} \qquad ( 19 )$$

$$arg {max}_{ω} ( S )$$

Here, regularization may be anyone among L2, L1, and L0 norms. Further, for the convenience, an L1 proximal operator or an L0 proximal operator may be applied since they may be convergent easily.

In this case, the target element may be shifted by one block (space) in the direction in which the element with the highest S in Equation (19) is located.

Here, after the target element has moved from the current location, the weight of the element corresponding to the current location may be set to ‘0’, this is, deactivated.

In this case, the initial value of the newly activated target element may be set to the value of S calculated in Equation (19).

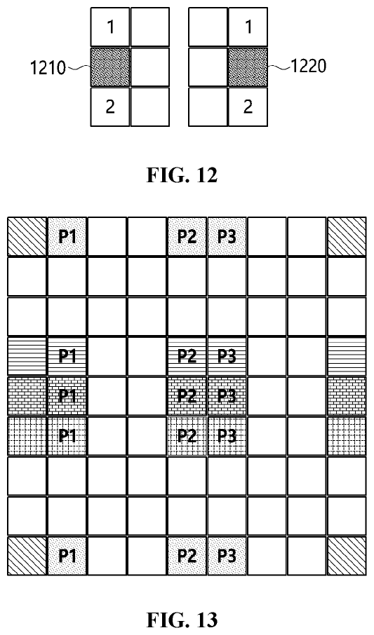

In another example, in the case of a target element (pixel) located on an edge, the number of elements adjacent to may be 2 at the most, as illustrated in FIG. 11 or 12. As illustrated in FIG. 11, when target elements 1110 and 1120 are located on the horizontal edge, each target element may be moved to left or right adjacent elements. When target elements 1210 and 1220 are located on the vertical edge, as illustrated in FIG. 12, each target element may be moved to upper or lower adjacent elements.

Thereafter, at the next forward propagating iteration, this rearranged weight matrix will be used in the dilated convolution layer. These routines may keep iterating until losses of the neural network can be low enough to predict the right answers.

In this case, since the new learning parameters are defined, which are based on the spatial information of the weight matrix in the present invention, it may has a lot of variants depending on how much atypical the kernel pattern is, this is, the degree of freedom about pattern, so it may need to be categorized.

Here, the learning parameters may include a base kernel size, a receptive field size, and sparsity corresponding to a value obtained by dividing the receptive field size by the base kernel size.

Typical dilated convolution may correspond to a form in which a parameter called a dilation rate is added to the conventional convolution. This may be a parameter introduced so as to generate a sparse filter by inserting zero-paddings between respective elements of the kernel.

For example, when a dilation rate=2 is applied to a base kernel having a 3*3 size, the kernel may be dilated to size of 5*5 so as to rearrange the non-zero elements in every other spot. That means the receptive field size may be expanded from 3*3 to 5*5. Reversely, the conventional convolution may be considered as a special case with a dilation rate=1.

A problem may arise in that, when the dilation rate is more than 2, the number of pixels that do not actually participate in a convolution operation in the receptive field may become greater than the number of pixels actually participating in the convolution operation. This means that the possibility of learning being performed without suitable information is increased.

The present invention is intended to assign a much higher degree of freedom to the locations of pixels participating in the convolution operation while maintaining the entire sparsity. However, when a heat map is configured completely freely, the receptive field of the kernel cannot be guaranteed, and thus there is required a constraint that enables the receptive field to be maintained.

In greater detail, the learning parameters will be defined as follows.

For example, in a 5*5 kernel dilated from a 3*3 kernel, the number of heat pixels may be 3*3, and the receptive field size may be 5*5. This means that sparsity may be (5*5)/(3*3)=25/9=2.78. Therefore, the present invention may use sparsity as a learning parameter instead of the dilation rate, and the minimum value of sparsity may be 1. That is, the case where sparsity is 1 may be the same as the case where the kernel of conventional convolution is used.

In this case, the greater the sparsity, the larger the receptive field. Here, a base kernel size forming a denominator may be an important parameter during a procedure for calculating the sparsity.

As the base kernel size is greater, the number of pixels (i.e., heat points) participating in the operation is larger, thus increasing a computational load. Therefore, suitably setting the base kernel size may be a very important factor.

Meanwhile, forming a numerator may be configured to define the size of the receptive field. Therefore, among 3*3 pixels (heat points), at least two points for which the difference between a minimum location and a maximum location on a horizontal axis must be 5 should be present, and at least two points for which the difference between a minimum location and a maximum location on a vertical axis must be 5 should be present.

However, sparsity cannot be unconditionally increased. The reason for this is that the size of the receptive field must be less than that of an input image. Assuming that the size of the input image has a dimension of 112×112, the magnitude of the denominator must be less than the dimension.

The learning parameters derived in this specific example are set forth in (1) to (4) below.
(1) sparsity
(2) base kernel size
(3) receptive field size
(4) constraint: the number of pairs that enable loc(max)-loc(min) to be equal to the receptive field size must be 1 or more for all dimensions

Further, sparsity can be derived from the base kernel size and the dilation rate, as represented by the following Equation (20) to support backward compatibility with conventional dilated convolution.

$${h}_{V} = ( {h}_{B} - 1 ) * ( l - 1 ) + 1 \qquad ( 20 )$$

$${w}_{V} - ( {w}_{B} - 1 ) * ( l - 1 ) + 1$$

$$S = \frac{{h}_{V} * {w}_{V}}{{h}_{B} * {w}_{B}}$$

Here, the base kernel size may be h_{B}*w_{B}, the dilation rate may be l, the receptive field size may be h_{V}*w_{V}, and sparsity may be S.

In this case, the atypical kernel pattern may have a form corresponding to any one of a completely-free form, a vertex-fixed form, an edge-limited form, and a group-limited form, depending on the constraint.

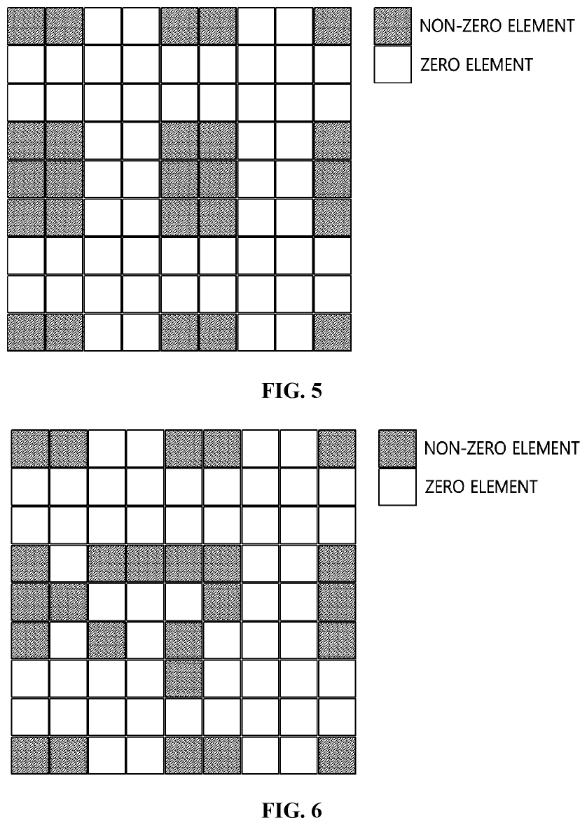

Here, the atypical kernel pattern is formed based on the form of the constraint that is set depending on the degree of freedom of the kernel, and may be deformed from the shape of a basic pattern identical to that of the conventional dilated convolution kernel illustrated in FIG. 4 into an atypical shape, such as that illustrated in FIGS. 5 to 8, through learning.

Here, all of the examples of the kernel pattern illustrated in FIGS. 4 to 8 correspond to a form which has a 9*9 receptive field and has 5*5 non-zero elements.

For example, the atypical kernel pattern having the group-limited form illustrated in FIG. 5 is limited such that rows and columns are grouped and then a convolution operation is moved on a group basis, and is capable of having a greatly limited degree of freedom. Therefore, this form of atypical kernel pattern has a low accuracy improvement effect, but has a simple pattern in comparison with other results, thus facilitating the implementation of lightweight calculation.

Further, the atypical kernel pattern having the edge (bounding line)-limited form illustrated in FIG. 6 is configured such that pixels (heat points) are located at the same points as those in conventional dilated convolution on a bounding line. Therefore, a boundary line is easy to identify a receptive field, but the degree of freedom is deteriorated, thus it may have as lower accuracy of learning as it is constrained.

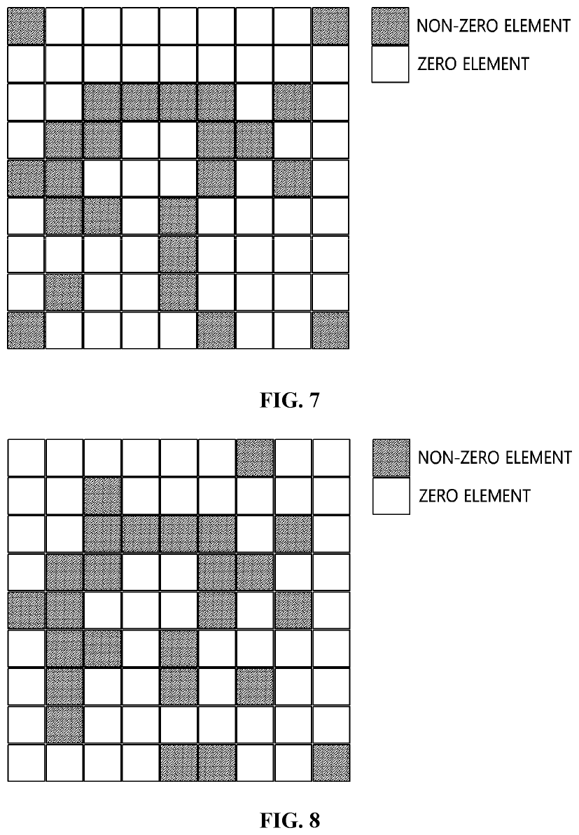

Furthermore, the atypical kernel pattern having the vertex-fixed form illustrated in FIG. 7 is configured such that pixels (heat points) are necessarily located at vertices of the receptive field, and is advantageous in that boundary points for desired receptive field can be identified.

In addition, the atypical kernel pattern illustrated in FIG. 8 has the most generic form, has the highest degree of freedom, and is generated to need only one or more pairs to satisfy the receptive field size on each axis.

Next, the method for performing a dilated convolutional operation using an atypical kernel pattern according to the embodiment of the present invention generates an atypical kernel pattern based on the learned weight matrix at step S120.

Here, the atypical kernel pattern may have a form corresponding to any one of a completely-free form, a vertex-fixed form, an edge-limited form, and a group-limited form depending on the constraint.

For example, the atypical kernel pattern may have a form, such as that illustrated in any of FIGS. 13 to 16.

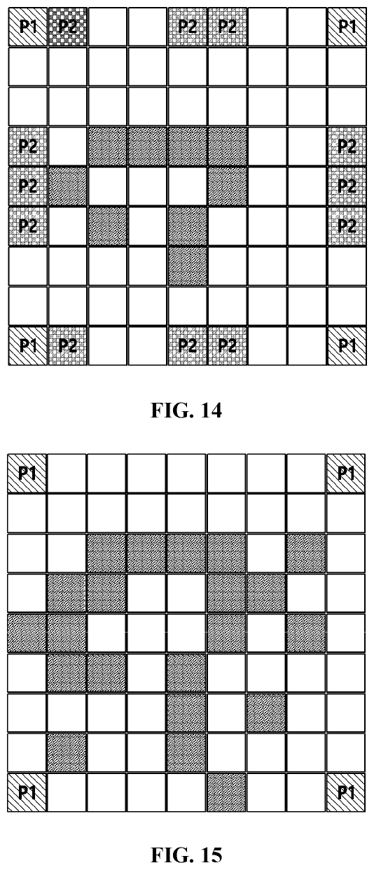

First, the atypical kernel pattern illustrated in FIG. 13 corresponds to the case where the atypical kernel pattern is limited such that rows and columns are grouped and then a convolution operation is moved on a group basis, and has a greatly limited degree of freedom. Therefore, the atypical kernel pattern has a low accuracy improvement effect, but is a simple pattern in comparison with the atypical kernel patterns illustrated in FIGS. 14 to 16, thus facilitating the reduction of computational load during inference. In this case, in FIG. 13, non-zero elements in the same column are indicated by the same character P1, P2, or P3, and non-zero elements in the same row are indicated by the same pattern. In this way, when a constraint is established such that elements that are not indicated by the same character and elements having the same pattern, rather than 0, are moved together, the result of learning the optimal location may be obtained.

Further, the atypical kernel pattern illustrated in FIG. 14 may correspond to the case where, among weight elements located on an edge, four vertices are fixed, and the remaining elements are limited to be movable only on the corresponding edge. In this case, there is an effect in that the contour of the receptive field may be maintained strong while the degree of freedom is assigned only in the receptive field.

Furthermore, the atypical kernel pattern illustrated in FIG. 15 may correspond to the case where only fourth vertices are immovably fixed and none of the remaining pixels are limited in motion. This atypical kernel pattern may be characterized in that the receptive field is minimally maintained.

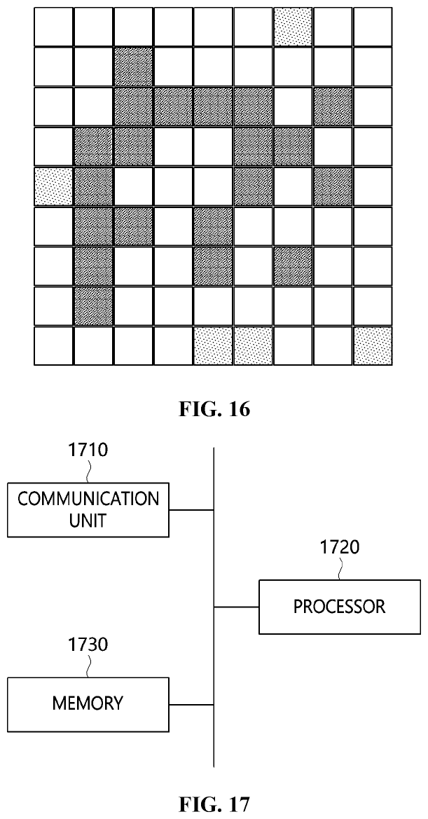

Finally, the atypical kernel pattern illustrated in FIG. 16 may correspond to the case where the degree of freedom is assigned to all elements. This may obtain the effect of best inference accuracy improvement, but a procedure for verifying whether the receptive field is maintained may be required each time.

Next, the method for performing a dilated convolution operation using an atypical kernel pattern according to the embodiment of the present invention performs a dilated convolution operation on the input data by applying the atypical kernel pattern to the kernel of the dilated convolutional neural network at step S130.

When the convolutional neural network to which the atypical kernel pattern is applied is used, the requirement to perform up-sampling may be considerably reduced, or may be completely obviated depending on the circumstances. That is, because down-sampling is not performed, spatial information may be maintained without change.

In order to maintain the spatial information without subsequent up-sampling using existing convolution, a structure requiring a considerably high computational load may be configured, and this structure is undesirable from the standpoint of usefulness of the convolutional neural network.

Further, by means of the method for performing a dilated convolution operation using an atypical kernel pattern according to the embodiment of the present invention, the deep-learning network may be trained using information of a place having a higher concentration while maintaining sparsity of the entire kernel. Furthermore, this information is generated in the form of a learnable parameter, thus enabling automated learning to be implemented such that the deep-learning network learns by itself rather than using a scheme of allowing a person to train the deep-learning network after going through trial and error.

By means of this automation, a convolution-unit computational load may be maintained, accuracy of learning may be improved, and an up-sampling or de-convolution step in an output stage may be reduced, and thus the entire deep-learning network may be configured to have a lightweight structure.

FIG. 17 is a block diagram illustrating a dilated convolutional neural network system according to an embodiment of the present invention.

Referring to FIG. 17, the dilated convolutional neural network system according to the embodiment of the present invention includes a communication unit 1710, a processor 1720, and memory 1730.

The communication unit 1710 may function to transmit and receive information required for the dilated convolutional neural network system through a communication network such as a typical network. Here, the network provides a path through which data is delivered between devices, and may be conceptually understood to encompass networks that are currently being used and networks that have yet to be developed.

For example, the network may be an IP network, which provides service for transmission and reception of a large amount of data and uninterrupted data service through an Internet Protocol (IP), an all-IP network, which is an IP network structure that integrates different networks based on IP, or the like, and may be configured as a combination of one or more of a wired network, a Wireless Broadband (WiBro) network, a 3G mobile communication network including WCDMA, a High-Speed Downlink Packet Access (HSDPA) network, a 3.5G mobile communication network including an LTE network, a 4G mobile communication network including LTE advanced, a satellite communication network, and a Wi-Fi network.

Also, the network may be any one of a wired/wireless local area network for providing communication between various kinds of data devices in a limited area, a mobile communication network for providing communication between mobile devices or between a mobile device and the outside thereof, a satellite communication network for providing communication between earth stations using a satellite, and a wired/wireless communication network, or may be a combination of two or more selected therefrom. Meanwhile, the transmission protocol standard for the network is not limited to existing transmission protocol standards, but may include all transmission protocol standards to be developed in the future.

The processor 1720 learns a weight matrix for the kernel of dilated convolution through deep learning.

Here, the location of a target element having a weight other than ‘0’ in the weight matrix may be moved in the direction in which the value of a loss function to which a regularization technique is applied is minimized.

Here, learning may be performed to satisfy a constraint that is set depending on the degree of freedom of a kernel in consideration of learning parameters defined based on the space information of the weight matrix.

Here, the learning parameters may include a base kernel size, a receptive field size, and sparsity corresponding to a value obtained by dividing the receptive field size by the base kernel size.

Here, learning may be performed while the receptive field size and the sparsity are maintained.

Here, when the weight loss value of the target element is greater than the hyperparameter of a proximal operator for regularization, the location of the target element may be moved to any one of multiple elements adjacent to the target element.

Here, the multiple adjacent elements may correspond to elements having weights of ‘0’ while being adjacent to the target element.

Here, the movement direction of the target element may be determined in consideration of the sparse coding value of the activated element located closest to the target element in directions facing the multiple adjacent elements.

Here, after the target element has been moved from the current location thereof, the weight of the element corresponding to the current location may be set to ‘0’.

Further, the processor 1720 generates an atypical kernel pattern based on the learned weight matrix.

Here, the atypical kernel pattern may have a form corresponding to any one of a completely-free form, a vertex-fixed form, an edge-limited form, and a group-limited form depending on the constraint.

Furthermore, the processor 1720 performs a dilated convolution operation on the input data by applying the atypical kernel pattern to the kernel of the dilated convolutional neural network.

The memory 1730 stores the atypical kernel pattern.

Also, as described above, the memory 1730 stores various types of information occurring in the dilated convolutional neural network system according to the embodiment of the present invention.

In an embodiment, the memory 1730 may be configured independently of the dilated convolutional neural network system, and may then support functionality for the dilated convolution operation. Here, the memory 1730 may operate as separate mass storage, and may include a control function for performing operations.

Meanwhile, the dilated convolutional neural network system may include memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage device.

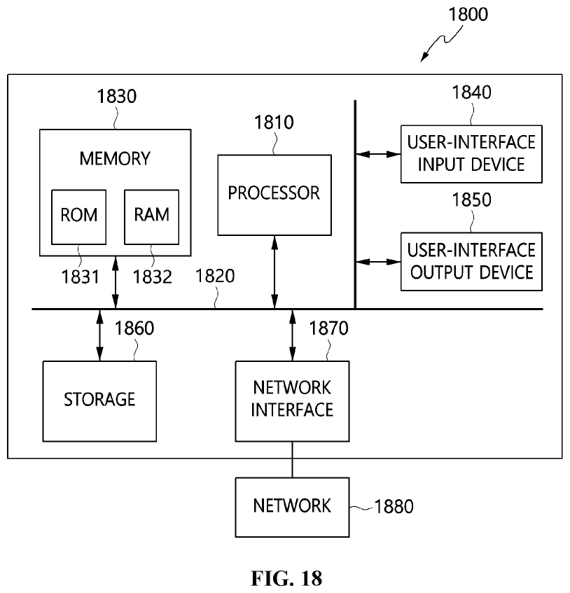

FIG. 18 is a diagram illustrating a computer system according to an embodiment of the present invention.

Referring to FIG. 18, the embodiment of the present invention may be implemented in a computer system, such as a computer-readable storage medium. As illustrated in FIG. 18, a computer system 1800 may include one or more processors 1810, memory 1830, a user interface input device 1840, a user interface output device 1850, and storage 1860, which communicate with each other through a bus 1820. The computer system 1800 may further include a network interface 1870 connected to a network 1880. Each processor 1810 may be a Central Processing Unit (CPU) or a semiconductor device for executing processing instructions stored in the memory 1830 or the storage 1860. Each of the memory 1830 and the storage 1860 may be any of various types of volatile or nonvolatile storage media. For example, the memory 1830 may include Read-Only Memory (ROM) 1831 or Random Access Memory (RAM) 1832.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

In accordance with the present invention, there can be provided a new convolution layer, which inherits the advantage of conventional dilated convolution technology and increases the degree of freedom of a kernel pattern while maintaining the receptive field and sparsity of dilated convolution so as to improve learning accuracy, thus improving the accuracy of learning.

Further, the present invention may provide a method for allowing a deep-learning network to learn by itself a new kernel pattern that is to be applied to dilated convolution in a train phase.

Furthermore, the present invention may increase a receptive field compared to a convolution using down-sampling without increasing a computational load, and may reduce an up-sampling or de-convolution cost in an output stage.

In addition, the present invention may assign the degree of freedom of a pattern so that better results can be obtained during a process for learning a dataset without fixing the kernel or filter pattern of dilated convolution.

As described above, in the method for performing a dilated convolution operation using an atypical kernel pattern and a dilated convolutional neural network system using the method according to the present invention, the configurations and schemes in the above-described embodiments are not limitedly applied, and some or all of the above embodiments can be selectively combined and configured so that various modifications are possible.

What is claimed is:

1. A method for performing a dilated convolution operation, comprising:
learning a weight matrix for a kernel of dilated convolution through deep learning;
generating an atypical kernel pattern based on the learned weight matrix; and
performing a dilated convolution operation on input data by applying the atypical kernel pattern to a kernel of a dilated convolutional neural network.

2. The method of claim 1, wherein learning the weight matrix comprises:
moving a location of a target element having a weight other than ‘0’ in the weight matrix in a direction in which a value of a loss function to which a regularization technique is applied is minimized.

3. The method of claim 2, wherein learning the weight matrix is configured to perform the learning to satisfy a constraint that is set depending on a degree of freedom of the kernel in consideration of learning parameters defined based on space information of the weight matrix.

4. The method of claim 3, wherein the learning parameters include a base kernel size, a receptive field size, and sparsity corresponding to a value obtained by dividing the receptive field size by the base kernel size.

5. The method of claim 4, wherein learning the weight matrix is configured to perform the learning while maintaining the receptive field size and the sparsity.

6. The method of claim 3, wherein the atypical kernel pattern has a form corresponding to any one of a completely-free form, a vertex-fixed form, an edge-limited form, and a group-limited form depending on the constraint.

7. The method of claim 2, wherein moving the location of the target element is configured to, when a weight loss value of the target element is greater than a hyperparameter of a proximal operation for regularization, move the location of the target element to any one of multiple adjacent elements.

8. The method of claim 7, wherein the multiple adjacent elements correspond to elements that are adjacent to the target element and have a weight of ‘0’.

9. The method of claim 8, wherein moving the location of the target element is configured to determine a movement direction of the target element in consideration of a sparse coding value of an activated element located closest to the target element in directions facing the multiple adjacent elements.

10. The method of claim 2, wherein moving the location of the target element is configured to, after the target element has been moved from a current location thereof, set a weight of an element corresponding to the current location to ‘0’.

11. A dilated convolutional neural network system, comprising:
a processor for learning a weight matrix for a kernel of dilated convolution through deep learning, generating an atypical kernel pattern based on the learned weight matrix, and performing a dilated convolution operation on input data by applying the atypical kernel pattern to a kernel of a dilated convolutional neural network; and
a memory for storing the atypical kernel pattern.

12. The dilated convolutional neural network system of claim 11, wherein the processor is configured to move a location of a target element having a weight other than ‘0’ in the weight matrix in a direction in which a value of a loss function to which a regularization technique is applied is minimized

13. The dilated convolutional neural network system of claim 12, wherein the processor is configured to perform the learning to satisfy a constraint that is set depending on a degree of freedom of the kernel in consideration of learning parameters defined based on space information of the weight matrix.

14. The dilated convolutional neural network system of claim 13, wherein the learning parameters include a base kernel size, a receptive field size, and sparsity corresponding to a value obtained by dividing the receptive field size by the base kernel size.

15. The dilated convolutional neural network system of claim 14, wherein the processor is configured to perform the learning while maintaining the receptive field size and the sparsity.

16. The dilated convolutional neural network system of claim 13, wherein the atypical kernel pattern has a form corresponding to any one of a completely-free form, a vertex-fixed form, an edge-limited form, and a group-limited form depending on the constraint.

17. The dilated convolutional neural network system of claim 12, wherein the processor is configured to, when a weight loss value of the target element is greater than a hyperparameter of a proximal operation for regularization, move the location of the target element to any one of multiple adjacent elements.

18. The dilated convolutional neural network system of claim 17, wherein the multiple adjacent elements correspond to elements that are adjacent to the target element and have a weight of ‘0’.

19. The dilated convolutional neural network system of claim 18, wherein the processor is configured to determine a movement direction of the target element in consideration of a sparse coding value of an activated element located closest to the target element in directions facing the multiple adjacent elements.

20. The dilated convolutional neural network system of claim 12, wherein the processor is configured to, after the target element has been moved from a current location thereof, set a weight of an element corresponding to the current location to ‘0’
